(19) United States
(12) Patent Application Publication
(10) Pub. No.: US 2004/0136773 A1
(43) Pub. Date: Jul. 15, 2004

(54) Brush with fluid delivery

(76) Inventor: Jason Matthew Costello, Auckland (NZ)

Correspondence Address: JACOBSON HOLMAN PLLC, 400 SEVENTH STREET N.W., SUITE 600, WASHINGTON, DC, 20004, US

(21) Appl. No.: 10/469,537

(22) PCT Filed: Mar. 6, 2002
(86) PCT No.: PCT/NZ02/00026

(30) Foreign Application Priority Data
Mar. 6, 2001 (NZ) 510372

(51) Int. Cl. A46B 11/06; A46B 5/02

(52) U.S. Cl. 401/289; 401/8

(57) ABSTRACT

A combination of a brush and a fluid delivery including: 1. A brush (3) comprising: A hand engageable member (1,4); A bristle providing region (2); and, A conduit engaging means (7); 2. A conduit (6) for delivering fluid to the brush (3); and 3. A control unit (5) for dispensing fluid to the brush (3) utilising a venturi effect.

### TECHNICAL FIELD

The present invention relates to a hygiene device. More particularly but not exclusively it relates to a hygiene device having a hand engageable member and a brush providing region engaged to, or for engagement to a hose.

### BACKGROUND

Different ways of maintaining hygiene in pets are known. Typically in the home the owners of dogs, for example, will attempt to clean their dog by bathing the dog. This can prove very difficult as dogs can be hard to control, as well as clean at the same time.

To deal with such problems currently available on the market are pet (particularly dog) cleaning services where an operator arrives at the premises with a trailer. The trailer includes a tub into which a dog is positioned and enclosed, for the cleaning by way of water and/or shampoo.

### OBJECT OF THE INVENTION

it is an object of the present invention to provide a hygiene device which is easier to use than the abovementioned prior art, or does not require professional assistance, or will at least provide the public with a useful choice.

### STATEMENTS OF THE INVENTION

According to a first aspect of the invention there is provided a hygiene device comprising or including:

a hand engageable member which includes a brush providing region, and

a means of delivering fluid to the brush providing region,

wherein the means for delivering fluid to the brush providing region is a conduit having an opening for engagement to a hose, the hose being attached at a first end to the opening and the second, distal end of the hose is connected to a control unit, and wherein the control unit includes a chamber within which shampoo and/or detergent or the like may be housed,

and wherein the control unit utilises a venturi effect for the dispensing of the shampoo and/or detergent or the like along with the flow of main fluid from the domestic water flow.

Preferably the control unit includes a fluid on/off valve or equivalent.

Preferably the control unit is engageable to a standard domestic hose connection outlet fitting.

Preferably the hand engageable member also includes a flow control valve.

Preferably the hand engageable member includes a main body portion from which the brush providing region extends brush members from a first major surface thereof.

Preferably the fluid and/or shampoo and/or detergent is or are delivered to or proximal to the first major surface.

Preferably from a second major surface of the main body portion there is provided a hand securable member such as a strap which is locatable over the hand of an operator to engage the hand between the body member and the strap.

According to a second aspect of the invention there is provided a hygiene device substantially as described herein with reference to one or both of FIGS. 1 and 2.

According to a third aspect of the invention there is provided a kit for assembling a hygiene device as previously described, the kit including:

a) a hand engageable member which includes—

a brush providing region, and

b) separately or integrally, a conduit for delivering fluid to the brush providing region, having an opening for engagement to a hose.

Preferably a length of hose is included, the hose being capable of attachment at a first end to the opening.

Preferably the hose is, or is capable of at the second, distal end connection to a control unit for flow control.

Preferably the control unit is included the control unit engageable to a standard domestic hose connection outlet fitting.

Preferably the control unit includes a chamber within which shampoo and/or detergent or the like may be housed.

Preferably the control unit utilises a venturi effect for the dispensing of the shampoo and/or detergent along with the flow of main fluid from the domestic water flow.

According to a fourth aspect of the invention there is provided a kit substantially as herein described with reference to one or both of FIGS. 1 and 2.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### DESCRIPTION OF THE DRAWINGS

FIG. 1 is a perspective view of the form that the hygiene device of the present invention may appear wherein a hand held member 1 provides a brushing region 2 and a hand engagable region 3 which preferably with co-operation of a strap 4 allows for a person to slide their hand underneath to hold the brush,

FIG. 2 is a perspective view of the control unit 5 which may include a venturi dispensable chamber for holding detergent and/or shampoo for dispensing along the conduit 6 for delivery to the hand held member 1.

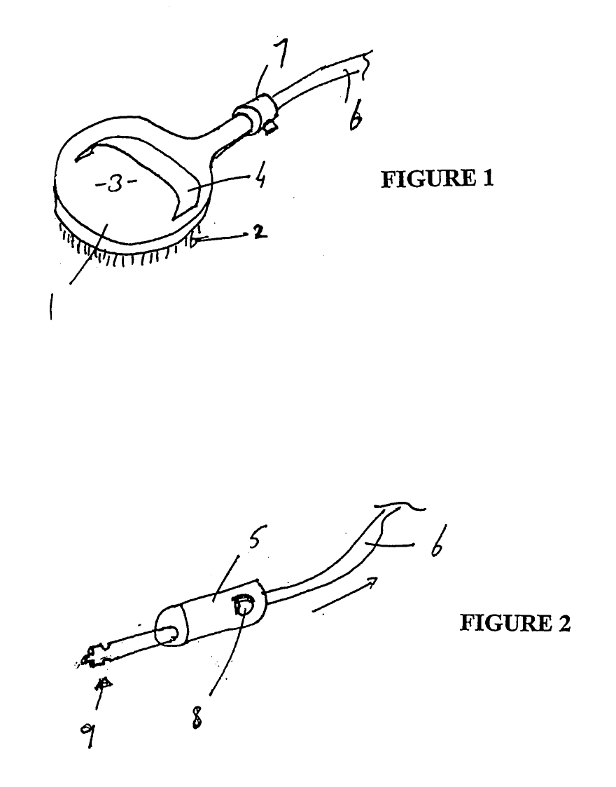

FIG. 1 shows the hand held member 1 which consists of a body portion from which brush members 2 extend to allow for convenient engagement of the brushes with the hide of a dog or pet or the like.

The hand held member 1 preferably includes an adjustable strap 4 which allows for a hand of the user of the device to be inserted thereunder and between the body portion to securely hold the hand held member 1.

The brush has a connection means 7 for connecting to a conduit 6 for the delivery of fluid to the hand held member 1.

At the distal end of the conduit 6 there is preferably provided a control unit 5. The control unit 5 preferably includes a valve for the control of fluid delivered from the conduit 6 to the hand held member 1. The fluid is preferably delivered to the side or face of the hand held unit where the brush members 2 are provided

The control unit 5 preferably includes a venturi-drainable chamber into which shampoo or other fluid to be dispensed along with the water from the domestic supply, can be provided. In other words the venturi effect resulting from passage of water from the domestic supply along the hose and through the control unit 5 will give rise to a venturi effect in the chamber housing the shampoo or other fluid, the shampoo or other fluid then will be forced to the hand held member 1.

A control knob 8 is preferably provided to allow for the rate of flow of shampoo or other fluid from the venturi emptied chamber to be controlled. A further or the same control knob 8 may also control the rate of fluid delivered to the conduit 6.

The control unit 5 preferably has means for plugging the control means into a standard domestic hose connection. This means 9 is preferably of the snap fit type nature.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

1. A hygiene device comprising or including:
a hand engageable member which includes a brush providing region, and
a means of delivering fluid to the brush providing region,
wherein the means for delivering fluid to the brush providing region is a conduit having an opening for engagement to a hose, the hose being attached at a first end to the opening and the second, distal end of the hose is connected to a control unit,
and wherein the control unit includes a chamber within which shampoo and/or detergent or the like may be housed,
and wherein the control unit utilises a venturi effect for the dispensing of the shampoo and/or detergent or the like along with the flow of main fluid from the domestic water flow.

2. A hygiene device as claimed in claim 1 wherein the control unit includes a fluid on/off valve or equivalent.

3. A hygiene device as claimed in claim 2 wherein the control unit is engageable to a standard domestic hose connection outlet fitting.

4. A hygiene device as claimed in claim 3 wherein the hand engageable member also includes a flow control valve.

5. A hygiene device as claimed in claim 4 wherein the hand engageable member includes a main body portion from which the brush providing region extends brush members from a first major surface thereof.

6. A hygiene device as claimed in claim 5 wherein the fluid and/or shampoo and/or detergent is or are delivered to or proximal to the first major surface.

7. A hygiene device as claimed in claim 6 wherein from a second major surface of the main body portion there is provided a hand securable member such as a strap which is locatable over the hand of an operator to engage the hand between the body member and the strap.

8. A hygiene device substantially as described herein with reference to one or both of FIGS. 1 and 2.

9. A kit for assembling a hygiene device as claimed in any one of the preceding claims, the kit including:
a) a hand engageable member which includes—
a brush providing region, and
b) separately or integrally, a conduit for delivering fluid to the brush providing region, having an opening for engagement to a hose.

10. A kit as claimed in claim 9 wherein a length of hose is included, the hose being capable of attachment at a first end to the opening.

11. A kit as claimed in claim 10 wherein the hose is, or is capable of at the second, distal end connection to a control unit for flow control.

12. A kit as claimed in claim 11 wherein the control unit is included the control unit engageable to a standard domestic hose connection outlet fitting.

13. A kit as claimed in claim 12 wherein the control unit includes a chamber within which shampoo and/or detergent or the like may be housed.

14. A kit as claimed in claim 13 wherein the control unit utilises a venturi effect for the dispensing of the shampoo and/or detergent along with the flow of main fluid from the domestic water flow.

15. A kit substantially as herein described with reference to one or both of FIGS. 1 and 2.
